(19) United States
(12) Patent Application Publication
(10) Pub. No.: US 2002/0082017 A1
(43) Pub. Date: Jun. 27, 2002

(54) Mobile communication terminal unit, and handoff control method thereof

(76) Inventor: Kiyoshi Hattori, Hino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/025,745

(22) Filed: Dec. 26, 2001

(30) Foreign Application Priority Data
Dec. 27, 2000 (JP) 2000-398099

(51) Int. Cl. H04Q 7/20

(52) U.S. Cl. 455/436; 455/437

(57) ABSTRACT

From a base station to which a mobile communication terminal is connected via a radio channel, the terminal receives first position information representing the position of the base station and at the same time, senses second position information representing the position of the terminal. Then, on the basis of the received first position information and the sensed second position information, the terminal calculates the distance between the base station and the terminal and, on the basis of the calculated distance, determines whether a handoff is needed.

### CROSS-REFERENCE TO RELATED APPLICATIONS

This application is based upon and claims the benefit of priority from the prior Japanese Patent Application No. 2000-398099, filed Dec. 27, 2000.

### BACKGROUND OF THE INVENTION

1. Field of the Invention

This invention relates to a mobile communication terminal with the function of performing handoff in, for example, a cellular mobile communication system; a handoff control method thereof.

2. Description of the Related Art

In recent years, cellular mobile communication systems, such as cellular phone systems, have been popularized rapidly. In the cellular mobile communication system, a plurality of base stations are provided in the service areas in a distributed manner. The base stations form the respective radio communication areas (or radio zones) called cells. A mobile communication terminal is connected via a radio channel to the base station in the radio zone where the terminal exists. The base station further connects the terminal to the called party's terminal via a wire communication network or the like, thereby enabling communication between mobile communication terminals or between a mobile communication terminal and a wire communication terminal.

When a mobile communication terminal moves from the present cell to another cell in the course of waiting for a call or communicating with the other party, a so-called handoff is performed. In handoff, the terminal is switched from the present base station to a new base station in the cell to which the terminal has moved. There are two types of handoff: a handoff within the same system and a handoff between different systems. In a handoff within the same system, a mobile communication terminal is switched between a plurality of base stations within the same system. In a handoff between different systems, a mobile communication terminal is switched between a plurality of systems differing in the radio communication scheme.

A handoff within the same system is performed as follows. A system using the Code Division Multiple Access (CDMA) scheme is taken as an example. While waiting for a call or communicating with the other party, a CDMA mobile communication terminal measures the reception level of the pilot signal the base station with which the terminal has established synchronization (hereinafter, referred to as the synchronized base station) is transmitting. At the same time, the CDMA mobile communication terminal measures the reception levels of the pilot signals the base stations in the vicinity of the terminal likely to be synchronized with the terminal (hereinafter, referred to as the neighboring base stations) are transmitting. When the reception levels of the pilot signals the neighboring base stations are transmitting have become equal to or higher than a specific level, or when the ratio of the reception level of the pilot signal the synchronized base station is transmitting to the reception level of the pilot signal each neighboring base station is transmitting has exceeded a specific value, the CDMA mobile communication terminal creates a message to request a handoff and transmits the message to the base station with which the terminal has established synchronization. At this time, the measured value of the reception level of the pilot signal received from the synchronized base station and the measured values of the reception levels of the pilot signals received from a plurality of neighboring base stations are inserted into the message to request a handoff.

In contrast, when receiving the message to request a handoff from the mobile communication terminal, the synchronized base station determines a handoff destination base station on the basis of the measured value of the reception level inserted in the message. Then, the synchronized base station notifies the requesting mobile communication terminal of the determined handoff destination base station. Receiving the notice, the mobile communication terminal returns a response to the synchronized base station. Then, the mobile communication terminal switches the connection from the present synchronized base station to a new base station according to the notice. In this way, a handoff is performed in the same system.

On the other hand, a handoff between different systems is performed as follows. When the power supply is turned on in a mobile communication terminal, the terminal searches for a system. The terminal selects a first system from the connectable systems according to a preset order of priority and establishes synchronization with a base station in the selected system. From this time on, the terminal starts the timer and measures the time. When the measured time of the timer has reached a specific time, the terminal searches for another system. In the re-searching, when the terminal has found a base station in another system whose reception quality is better than that of the base station in the system to which the terminal is now connected, the terminal switches the connection from the present station to the other one. In the switching, when the radio communication scheme of the system to which the terminal is going to be switched differs from that of the system to which the terminal is now connected, the operation mode of the mobile communication terminal is changed to the radio communication scheme of the system to which the terminal is going to be switched.

Use of this type of terminal enables radio communication to be continued by switching the connection to a base station in another system, even when it becomes difficult for the terminal to communicate with its base station. This is very convenient for users.

In the handoff control method within the same system, whether a handoff is needed is determined on the basis of the reception level of the pilot signal coming from a base station. Therefore, when the reception level of the pilot signal coming from the base station fluctuates temporarily, this might prevent a handoff from being performed properly.

For example, even when a mobile communication terminal exists relatively close to the synchronized base station, a temporary drop in the reception level due to a sudden movement of the mobile communication terminal or the influence of the surrounding buildings might cause an unnecessary handoff to be performed to another base station. At this time, the mobile communication terminal consumes power wastefully, shortening the battery service life. Conversely, even when the mobile communication terminal is far away from the synchronized base station, if the terminal is in a special place where it can receive a pilot signal in a good condition, a handoff which is supposed to be performed is not carried out. In this case, a slight movement of the mobile communication terminal might cause the reception level of the signal to drop abruptly. As a result, a handoff might not be performed in time, leading to the collapse of the synchronization or disconnection of the channel.

On the other hand, in the handoff between different systems, whether a handoff is needed in waiting for a call is determined at regular intervals on the basis of the measured time of the timer. Therefore, even when the quality of the reception of the pilot signal coming from the synchronized system deteriorates due to the movement of the mobile communication terminal during the measuring period of the timer and this requires the terminal to be switched to another system, a handoff is not performed.

Conversely, even when the mobile communication terminal has hardly moved and there is no need for a handoff to another system, the terminal searches for a base station each time the timer reaches the time out. As a result, even when an incoming call addressed to the mobile communication terminal has arrived during the re-searching period, the mobile communication terminal cannot receive the notice. Furthermore, each time an unnecessary handoff process is carried out, the mobile communication terminal consumes electric power accordingly, which is one of the factors that shorten the battery service life.

### BRIEF SUMMARY OF THE INVENTION

The object of the present invention is to provide a mobile communication terminal which reduces the power consumption and improves the reliability of the handoff operation, by determining whether a handoff is needed without solely depending on the quality of signal reception or the timer, and thereby decreasing unnecessary handoff processes, and further provide a handoff control method thereof.

According to an aspect of the present invention, a mobile communication terminal, from a base station to which the terminal is connected via a radio channel, receives first position information representing the position of the base station and at the same time, senses second position information representing the position of the terminal. Then, on the basis of the received first position information and the sensed second position information, the terminal calculates the distance between the base station and the terminal and, on the basis of the calculated distance, determines whether a handoff is needed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows a schematic configuration of a cellular mobile communication system according to a first embodiment of the present invention;

FIG. 2 is a block diagram showing the configuration of a mobile communication terminal used in the system of FIG. 1;

FIG. 3 is a flowchart to help explain the procedure for handoff control performed in the control section of the mobile communication terminal of FIG. 2;

FIG. 4 is a flowchart to help explain the procedure for the process of determining whether a handoff is needed carried out in the control section of the mobile communication terminal of FIG. 2;

FIG. 5 is a drawing to help explain the operation of determining whether a handoff is needed carried out in the mobile communication terminal of FIG. 2;

FIG. 6 is an example of a cell information table provided in a mobile communication terminal in another embodiment of the present invention; and

FIG. 7 is an example of a threshold value table provided in another embodiment of the present invention.

### DETAILED DESCRIPTION OF THE INVENTION

(First Embodiment)

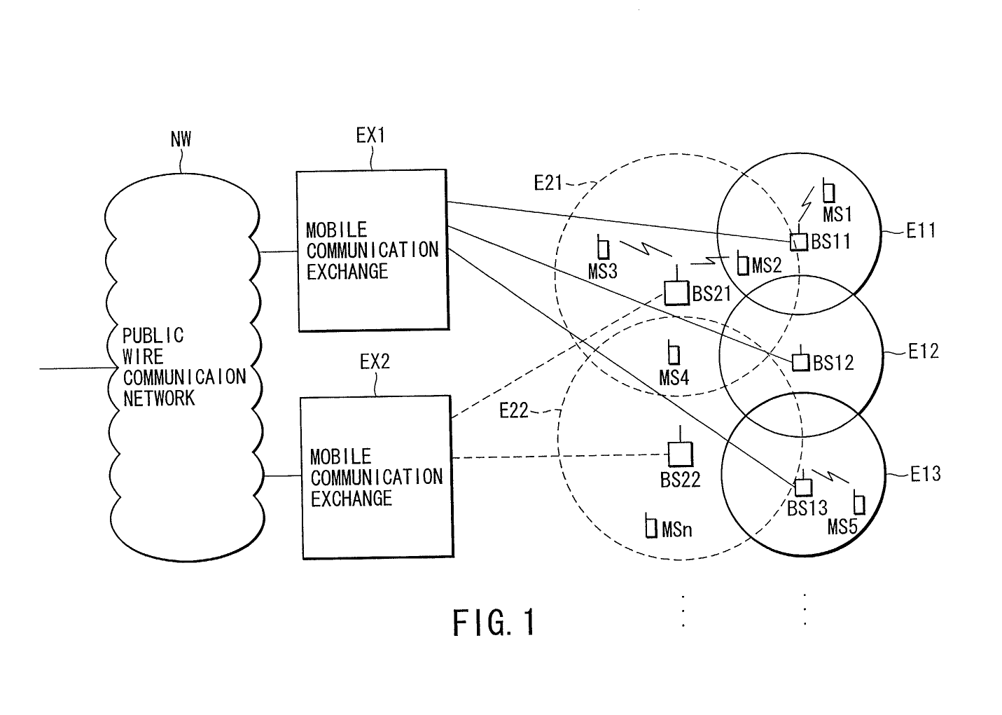

FIG. 1 shows a schematic configuration of a cellular mobile communication system according to a first embodiment of the present invention.

The cellular mobile communication system according to the first embodiment comprises a first system run by a first communication operator and a second system run by a second communication operator who has all or part of the service area of the fist system as its service area. The first system differs from the second system in the radio communication scheme and communication protocol.

For example, a digital automobile telephone system using the CDMA (Code Division Multiple Access) scheme can be regarded as the first system. A personal mobile communication system using the CDMA scheme, such as PCS (Personal Communication System), or an analog mobile communication system using an analog communication scheme, such as AMPS (Advanced Mobile Phone System), can be regarded as the second system.

In the service area covered by the first system, a plurality of base stations BS11, BS12, . . . are provided in a distributed manner. The base stations BS11, BS12, . . . form the respective radio communication areas E11, E12, . . . called cells. Each of the base stations BS11, BS12, . . . is connected to a first mobile communication exchange EX1 via a wire communication channel. The first mobile communication exchange EX1 is connected to a public wire communication network NW.

Furthermore, in the service area of the first system, a plurality of base stations BS21, BS22, . . . belonging to the second system are provided in a distributed manner. The base stations BS21, BS22, form the respective radio communication areas E21, E22, . . . called cells. Each of the base stations BS21, BS22, . . . is connected to a second mobile communication exchange EX2 via a wire communication channel. The second mobile communication exchange EX2 is connected to the public wire communication network NW.

Mobile communication terminals (or mobile stations) MS1 to MSn are composed of the so-called dual-mode terminals which have the function of dealing with the radio communication schemes and communication protocols of the first and second systems. For example, they have the function of dealing with both a digital automobile telephone system using the CDMA scheme and a PCS using the CDMA scheme. The mobile communication terminal is connected via a radio channel to the base station that forms a cell in which the terminal exists.

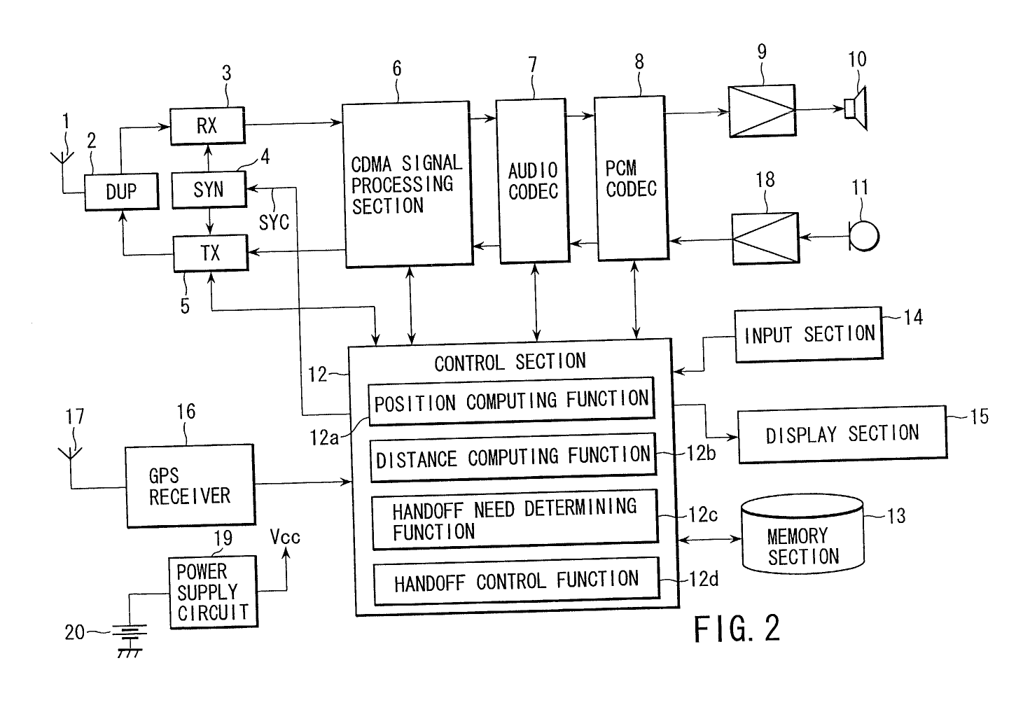

Each of the mobile communication terminals MS1 to MSn is configured as follows. FIG. 2 is a block diagram showing its configuration.

In FIG. 2, the radio signal transmitted from a base station (not shown) is received by a mobile communication antenna 1 and then inputted to a receiving circuit (RX) 3 via a duplexer 2 (DUP). In the receiving circuit 3, the radio signal is mixed with the receiving local oscillation signal outputted from a frequency synthesizer (SYN) 4 and thereby frequency-converted into an intermediate frequency signal. The frequency of the local oscillation signal generated at the frequency synthesizer 4 is specified by the control signal SYC from a control section 12.

A CDMA signal processing section 6 subjects the intermediate frequency signal to an orthogonal demodulation process. The demodulated signal is subjected to an inverse diffusion process using diffusion codes allocated to the receiving channel, thereby obtaining the demodulated data in a specific format according to the data rate. Then, the demodulated data is inputted to an audio coding and decoding section (hereinafter, referred to as an audio codec) 7. The information indicating the data rate in the demodulated data is inputted to the control section 12.

The audio codec 7 subjects the demodulated data outputted from the CDMA signal processing section 6 to an expansion process according to the received data rate notified by the control section 12. Then, the codec 7 subjects the expanded demodulated data to a decoding process using Viterbi decoding or the like and an error correction decoding process, thereby reproducing the received digital data in the baseband.

A PCM coding section (hereinafter, referred to as a PCM codec) 8 carries out a signal process corresponding to the type of communication according to the control signal representing the type of communication (audio communication or data communication) outputted from the control section 12. That is, in audio communication, the received digital data outputted from the audio codec 7 is PCM-decoded, thereby outputting the analog received signal. The analog received signal is amplified by a receiver amplifier 9 and then outputted in sound from a speaker 10. In data communication, the received digital data outputted from the audio codec 7 is outputted to the control section 12. The control section 12 stores the received digital data in a memory section 13. As the need arises, the received digital data is outputted from an external interface (not shown) to a personal digital assistants (PDA) (not shown) or a notebook personal computer (not shown).

The speaker's transmitted audio signal inputted to a microphone 11 during audio communication is amplified to the proper level by a transmitter amplifier 18. The PCM coding section 8 subjects the amplified transmitted signal to PCM coding, thereby producing transmitted audio data. This audio data is inputted to the audio codec 7. The text data outputted from a PDA (not shown) or a notebook personal computer (not shown) or the image data outputted from a camera (not shown) is inputted via an external interface to the control section 12. The control section 12 inputs the inputted data to the audio codec 7.

In audio communication, the audio codec 7 senses the amount of energy in the inputted sound from the transmitted audio data supplied from the PCM codec 8 and determines the data rate on the basis of the result of the sensing. Then, the transmitted audio data is compressed into a burst signal in the format corresponding to the data rate. After the compressed data is subjected to an error correction coding process, the resulting data is outputted to the CDMA signal processing section 6. In data communication, the transmitted data, such as the inputted text data or image data, is compressed into a burst signal in the format corresponding to the preset data rate. After the compressed data is subjected to the error correction coding process, the resulting data is outputted to the CDMA signal processing section 6. The data rate in either audio communication or data communication is notified as the transmitted data rate to the control section 12.

The CDMA signal processing section 6 subjects the burst signal outputted from the audio codec 7 to a diffusion process using diffusion codes. Then, the section 6 subjects the diffusion-coded transmission signal to orthogonal modulation, and supplies this signal to a transmission circuit (TX) 5.

The transmission circuit 5 combines the orthogonally-modulated signal with the transmission local oscillation signal generated at the frequency synthesizer 4, thereby converting the orthogonally-modulated signal into a radio signal. Then, on the basis of the transmission data rate specified by the control section 12, the transmission circuit 5 high-frequency-amplifies only the effective part of the radio signal and outputs it as a transmission radio signal. The transmission radio signal outputted from the transmitting circuit 5 is supplied via the duplexer 2 to the antenna 1 where it is transmitted to a base station (not shown).

An input section 14 is provided with keys, including dial keys, a call start key, a power key, an end key, a volume control key, and a mode key. A display section 15 is provided with an LCD display and an LED lamp. On the LCD indicator, the telephone number of the called user, the operating state of the terminal, the transmitted data, the received data, etc. is displayed. The LCD display also displays information about the remaining capacity of a battery 16. The LED lamp is used for displaying the charged state of the battery 16. It is also used for informing the user of an incoming call. Numeral 17 indicates a power supply circuit, which produces a specific operating power supply voltage Vcc according to the output of the battery 16 and supplies the voltage to each circuit section.

Each of the mobile communication terminals MS1 to MSn is provided with a GPS (Global Positioning System) receiver 16. The GPS receiver 16 receives the GPS signals transmitted from a plurality of GPS satellites (not shown) and supplies the received signals to the control section 12 as the data for sensing the position of the terminal.

The control section 12 includes a microprocessor, a memory that stores a program the microprocessor executes, and an input/output interface. The memory stores not only a program that realizes primary control functions, including radio channel selection control and data transmission/reception control, but also a program that realizes a position computing function 12a, a distance computing function 12b, a handoff need determining function 12c, and a handoff control function 12d.

The position computing function 12a receives the GPS signals from the GPS satellites by the GPS receiver 16, in a specific period of T2. On the basis of the received GPS signals, the position computing section calculates latitude and longitude data representing the position of the terminal.

From the system parameter message received from the base station with which the terminal has established synchronization (or the synchronized base station), the distance computing function 12b extracts latitude and longitude data representing the position of the base station. Then, the position computing function 12a calculates the distance Rdet from the base station to the terminal on the basis of the latitude and longitude data representing the position of the base station and the latitude and longitude data representing the position of the terminal calculated by the position computing section 12a.

The handoff-determining function 12c extracts the information representing the threshold value from the system parameter message, access parameter message, or neighbor list message received from the synchronized base station. On the basis of the information representing the extracted threshold value, a threshold value for determining whether a handoff is needed is set. Next, the distance Rdet calculated by the distance computing function 12b is compared with the threshold value. If the distance is greater than the threshold value, it is determined that handoff is needed, and if the distance is less than or equal the threshold value, it is determined that a handoff is not needed.

When the power supply is turned on, or when the handoff determining function 12c has determined that handoff is needed, the handoff control section 12d searches for a base station in another system and determines the base station as the next destination of a handoff on the basis of the result of the search. Then, the handoff control function 12d performs control so as to change the connection of the terminal from the base station to which the terminal is now connected to the base station determined to be the destination of the handoff.

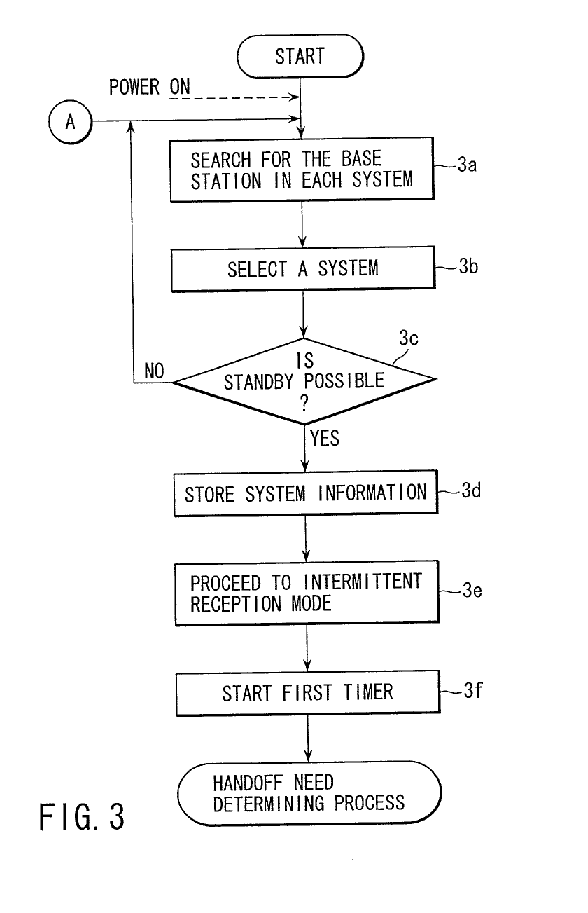

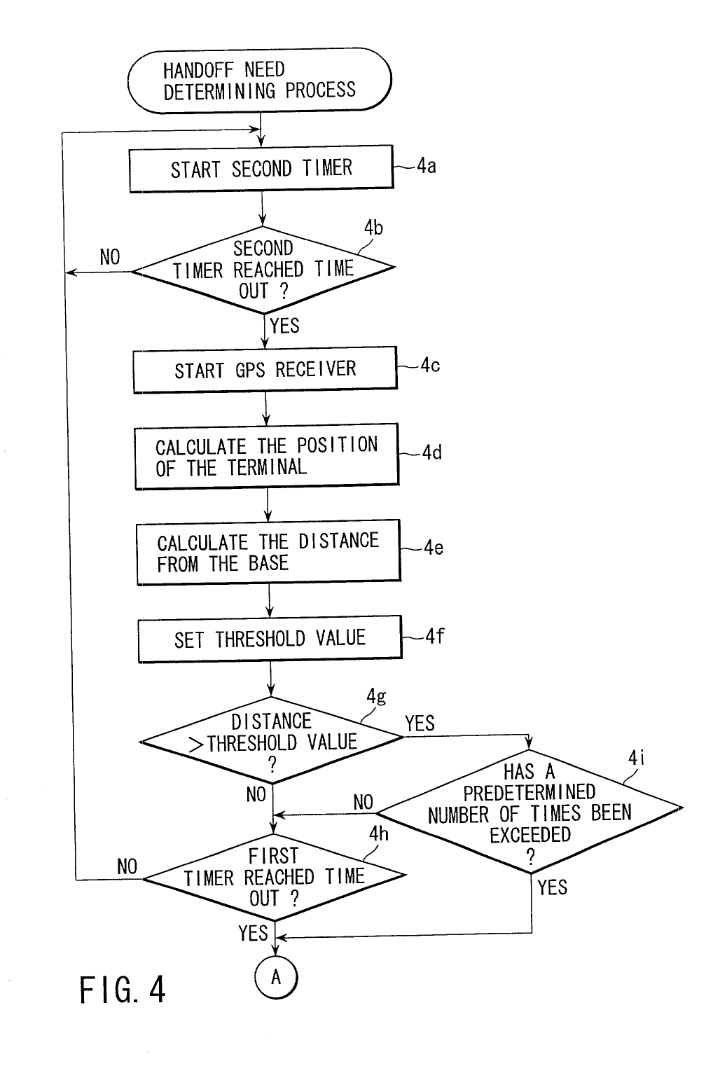

Next, the process of determining whether a handoff is needed and the handoff control process at each of the mobile communication terminals MS1 to MSn configured as described above will be explained. FIGS. 3 and 4 are flowcharts to help explain the procedure and contents of handoff control.

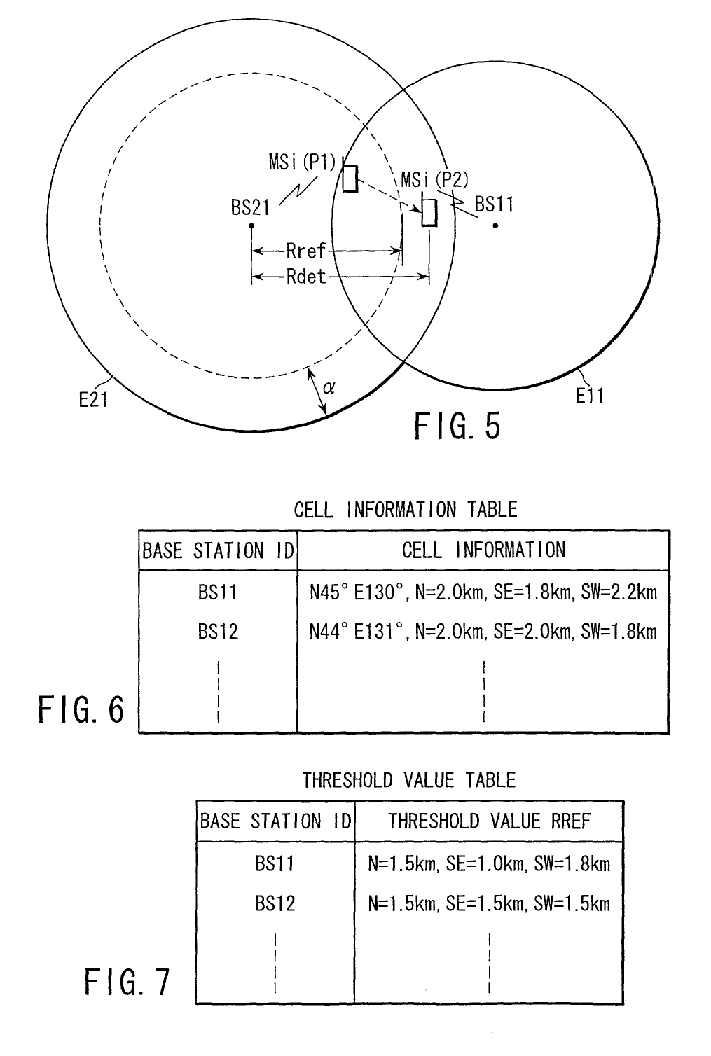

It is assumed that the power supply of a mobile communication terminal MSi is turned on at position P1 shown in FIG. 5. Then, in the mobile communication terminal MSi, the control section 12 performs control so as to acquire base station information from the neighboring base stations.

Each CMDA base station transmits a pilot channel, a sync channel, and a paging channel. A mobile communication terminal MS receives the pilot channel, sync channel, and paging channel in this order, thereby capturing base stations (step 3a). Then, in step 3b, the mobile communication terminal MS selects the one with the best condition from the captured base stations. The base station with the best condition is selected as follows. From the captured base stations, the terminal MS selects more than one base station in the system with the highest priority according to the preset order of priority of system selection. Then, from the selected base stations, the terminal MS selects the one with the best reception quality. For example, the terminal MS selects base station BS21 in the second system in FIG. 5.

Next, the control section 12 of the mobile communication terminal MSi establishes synchronization with the selected base station BS21. After verifying that synchronization has been established, the terminal MSi proceeds from step 3c to step 3d, where the terminal MSi acquires various pieces of system information from the base station BS21.

That is, each base station transmits notice information using the paging channel. The system parameter message included in the notice information includes identification information about the base station (or base station ID) and position information about the base station. The position information about the base station is represented by latitude and longitude data. From the system parameter message in the notice information transmitted from the synchronized base station BS21, the mobile communication terminal MSi extracts position information about the base station BS21.

Furthermore, each base station is transmitting a neighbor list message in the notice information. The mobile communication terminal MSi receives the neighbor list message transmitted from the synchronized base station BS21 and obtains pieces of information about the neighboring base stations in the same system from the message. On the basis of the acquired information about the neighboring base stations, the terminal MSi captures the neighboring base stations one after another and receives the notice information from them. From the system parameter messages in these pieces of notice information, the terminal MSi extracts the position information about each of the neighboring stations.

After acquiring position information about the synchronized base station and that about the neighboring base stations, the control section 12 of the mobile communication terminal MSi stores these acquired pieces of position information in a base station information table in the memory section 13 (step 3d). The received system parameter message may be stored as it is. Then, the control section 12 of the mobile communication terminal MSi sets the operation mode of the terminal MSi to the intermittent reception mode in step 3e. At the same time, the control section 12 causes a first timer to start in step 3f and thereafter goes into the waiting state. The first timer measures the period for determining whether a handoff between different systems is needed, which will be explained later.

After going entering the waiting state, the mobile communication terminal MSi causes the control section 12 not only to monitor the arrival of an incoming call or an idle handoff in the same system, but also to carry out the process of determining whether a handoff between different systems is needed. An idle handoff in the same system is the process of switching the connection of the terminal MSi between the base stations in the same system.

That is, the control section 12 of the mobile communication terminal MSi starts a second timer at step 4a as shown in FIG. 4. The second timer measures the period for sensing the position of the terminal MSi. For example, after the second timer measures five seconds and reaches the time out, the mobile communication terminal MSi proceeds from step 4b to step 4c, where the terminal MSi starts the GPS receiver 16. Then, the GPS receiver 16 receives the GPS signals transmitted from a plurality of GPS satellites and inputs the distance measuring data included in the signals to the control section 12.

In step 4e, the control section 12 calculates latitude and longitude data representing the position of the terminal on the basis of the distance measuring data inputted from the GPS receiver 16. Then, in step 4d, the control section 12 reads the latitude and longitude data representing the position of the synchronized base station BS21 from the system parameter message previously acquired and stored in the memory section 13. On the basis of the read-out latitude and longitude data about the base station BS21 and the latitude and longitude data about the terminal calculated in step 4d, the control section 12 calculates the distance from the base station BS21 to the terminal.

Next, in step 4f, the control section 12 reads the threshold value specifying data from the system parameter message and, on the basis of the specifying data, sets a threshold value Rref for determining whether a handoff is needed. As shown by a broken line in FIG. 5, the threshold value Ref is set to a value a specific margin a shorter than the diameter of radio communication area E21 the base station BSi forms. Then, in step 4g, the control section 12 compares the distance Rdet from the base station to the terminal calculated in step 4e with the threshold value Rref for determining whether a handoff is needed, set in step 4f. Then, the control section 12 determines whether the distance, Rdet, is greater than the threshold value, Ref.

It is assumed that the mobile communication terminal MSi moves from position P1 to position P2 as shown in FIG. 5. In this case, as seen from FIG. 5, the distance Rdet from the synchronized base station BS21 to the mobile communication terminal MSi is greater than the threshold value Rref. The control section 12 counts the number of times the distance Rdet exceeds the threshold value Rref. It is further assumed that the count has exceeded the preset number of times (for example, three times). Then, the control section 12 determines that a handoff between different systems is needed and proceeds from step 4i to step 3ain FIG. 3. From this point on, the control section 12 carries out handoff between different systems in step 3a to step 3f.

That is, the control section 12 changes the operation mode of the terminal to the continuous reception mode and then searches for neighboring base stations in step 3a. Then, from the neighboring base stations captured in the search, the control section 12 selects the base station belonging to the system second in the order of priority of system selection different from the synchronized system (step 3b). For example, in the example of FIG. 5, the control section 12 selects base station BS11 in the first system, as opposed to the synchronized second system.

Then, after establishing synchronization with the selected base station BS11 in step 3c, the control section 12 proceeds from step 3c to step 3d, where it acquires system information from the newly synchronized base station BS11 and the base stations BS12, . . . adjacent to the base station BS11. The control section 12 stores the acquired system information in the memory section 13. Then, in step 3e, the control section 12 sets the operation mode of the terminal to the intermittent reception mode. At the same time, in step 3f, the control section 12 starts the first timer again and thereafter goes into the waiting mode.

In this way, the mobile communication terminal MSi is handed off from one system to another system, that is, from the second system to the first system.

On the other hand, if it has been determined in step 4g that the distance Rdet is less than or equal to the threshold value of Rref, or if it has been determined in step 4i that the count is equal to or smaller than three times, the control section 12 determines that a handoff between different systems is not needed, and proceeds to step 4h. Then, in step 4h, the control section determines that the first timer to determine the period for determining whether a handoff between different systems is needed has reached the time out. The result of the determination has shown that the first timer has not reached the time out, so the control section 12 returns to step 4a. Then, the control section 12 carries out repeatedly the process of determining whether a handout between different systems is needed in step 4a to step 4h.

In contrast, it is assumed that, for example, three minutes has passed without the execution of a handoff between different systems and therefore the first timer has reached the time out. Then, the control section 12 returns from step 4h to step 3a in FIG. 3. From this point on, the control section 12 carries out a handoff between different systems in step 3a to step 3f.

That is, if the state where a handoff between different systems is not performed continues for three minutes, a handoff between different system is performed forcibly in the mobile communication terminal MSi. Therefore, although the mobile communication terminal MSi is connected to a base station in the system first in the order of priority of system selection at the time of turning on the power supply, if the quality of the reception is not good, an elapse of three minutes or the count limit of the first timer forces the terminal MSi to be handed off to a base station in another system. This prevents the terminal MSi from being connected semipermanently to a base station in a system whose reception quality is poor.

As described above, the mobile communication terminal of the first embodiment calculates information about its position on the basis of the GPS signal received by the GPS receiver 16 in a specific period in the waiting state. On the basis of the position information about the terminal and the position information about the base station notified in the system parameter message from the synchronized base station, the terminal calculates the distance Rdet from the base station to the terminal. Then, the terminal compares the calculated distance Rdet with the threshold value Rref notified from the base station. When the calculated distance Rdet becomes larger than the threshold value Rref, the terminal determines that it is more than the threshold value Rref away from the base station and executes a handoff between different systems.

Therefore, with the first embodiment, on the basis of the distance Rdet from the base station to the mobile communication terminal, it is determined whether a handoff is needed. This makes it possible to determine properly whether a handoff is needed without the influence of changes in the radio propagation environment between the base station and the mobile communication terminal.

The position of the terminal is calculated on the basis of the GPS signals transmitted from GPS satellites. As a result, the position of the terminal can be always calculated accurately regardless of the state of the radio waves between the base station and the mobile communication terminal. This makes it possible to correctly determine whether handoff is needed.

In addition, handoff between different systems is performed not only when the distance Rdet from the base station to the mobile communication terminal has exceeded the threshold value Rref, but also when a specific time, determined by the first timer, has elapsed without the execution of handoff between the different systems, as the mobile communication terminal was connected to the present system. Therefore, when the state where handoff is not carried out continues for a specific length of time, handoff between different systems is performed forcibly in the mobile communication terminal. This prevents the terminal from being connected semi-permanently to a base station in a system whose reception quality is poor.

(Second Embodiment)

In the first embodiment, when the distance from the base station to the mobile communication terminal has become greater than the threshold value for determining whether a handoff is needed, a handoff between different systems has been performed. The present invention is not restricted to this. For instance, when the distance from the base station to the mobile communication terminal becomes greater than the threshold value, for determining whether a handoff is needed, an idle handoff may be performed between base stations in the same system.

In this case, in step 3a in FIG. 3, a base station in another system is searched for and, at the same time, another base station belonging to the synchronized system is searched for. Then, in step 3b, on the basis of the result of searching for another base station belonging to the synchronized system, a suitable one is selected as a handoff destination from the other base stations in the same system. Then, after the processes in step 3d to step 3f are carried out, a handoff is performed on the selected base station in the same system.

In contrast, when there is no suitable handoff destination in the base stations in the same system, a base station of a suitable system is selected as the destination of handoff between different systems, on the basis of the result of searching for a base station in another system in step 3b. Then, handoff is performed on the selected base station in another system.

By doing this, an idle handoff is performed on a base station in the same system in preference to a handoff between different systems. Then, when an idle handoff in the same system is impossible, a handoff between different systems is performed. Thus, handoff can be performed giving priority to the system to which the terminal belongs.

The order of priority of handoff may be so determined that a handoff between different systems is first performed and then an idle handoff to a base station in the same system is performed.

Furthermore, the order of priority of handoff may be changed on the basis of the result of searching for a base station. For instance, the result of searching for a base station in another station is compared with the result of searching for a base station in the synchronized system. Then, the best one is selected as a handoff destination from the base station searched for. Thereafter, a handoff is performed on the selected base station.

(Third Embodiment)

In the first and second embodiments, the following two handoff executing conditions have been used:

(1) When the distance Rdet from the base station to the mobile communication terminal becomes greater than the threshold value Rref for determining whether a handoff is needed.

(2) When a specific time determined by the first timer has elapsed without the execution of a handoff since the mobile communication terminal was connected to the present system.

The present invention is not limited to these conditions. For instance, a handoff may be executed using only item (1) as a condition.

By doing this, the following disadvantage is overcome: for example, when a handoff between different systems is performed, a system search is made unnecessarily each time the condition in item (2) is fulfilled, even though the mobile communication terminal is connected to a system whose reception quality is good. Eliminating the above disadvantage enables the power consumption to be reduced further.

In the cellular mobile communication system, an idle handoff is generally performed in the same system according to the quality of reception. Therefore, it is possible to always keep the reception quality of the mobile communication terminal above a specific level. As a result, there arises almost no problem even if the process of performing a handoff between different systems using the condition in item (2) is eliminated.

Furthermore, the condition in item (2) may be so improved that, when the first timer has reached the time out, the reception quality at that time is sensed and, only when the sensed reception quality has deteriorated below a specific threshold value, a handoff is executed. This prevents a handoff from being performed unnecessarily even if the reception quality is good.

Furthermore, to the conditions in item (1) and item (2), the following condition may be added:

(3) When the reception quality of the mobile communication terminal deteriorates continuously below the threshold value for a specific length of time.

By doing this, a handout can be executed early without waiting for the first timer to reach the time out, when the reception level of the mobile communication terminal is below the threshold value level continuously for a specific length of time before the first timer reaches the time out in item (2).

(Fourth Embodiment)

In the first embodiment, the threshold value used for determining whether a handoff is needed has been given from a base station. The present invention is not limited to this. For instance, the following embodiment can be considered.

A cell information table that stores cell information about base stations is provided for a mobile communication terminal. In the cell information table, cell information about the cells a plurality of base stations expected to be synchronized with the mobile communication terminal (or expected to be connected to the mobile communication terminal) form is stored in advance in such a manner that the cell information corresponds to identification information (or base station IDs) about the base stations.

The cell information is composed of latitude and longitude data representing the position of the base station and data representing the shape and size of the cell. The data representing the shape and size of the cell is expressed by the azimuths representing the directivity of three sectors and the effective range (or distance). FIG. 6 shows an example of them. In FIG. 6, for example, in the case of base station BS11, latitude 45° N and longitude 130° E (45° N, 130° E) is stored as latitude and longitude data. As for the data representing the shape of the cell and its size, the following are stored: the effective range of the northside sector is 2.0 km (N=2.0 km), the effective range of the southeast-side sector is 1.8 km (SE=1.8 km), and the effective range of the southwest-side sector is 2.2 km (SW=1.8 km).

The mobile communication terminal extracts the base station ID from the notice information transmitted from the base station and reads the cell information corresponding to the extracted base station ID from the cell information table. Then, on the basis of the latitude and longitude data about the base station included in the cell information and the latitude and longitude data about the terminal, the distance Rdet from the terminal to the base station is calculated. Furthermore, on the basis of the latitude and longitude data about the base station, the latitude and longitude data about the terminal, and the data representing the shape of the cell and its size included in the read-out cell information, the threshold value Rref is set. Then, the calculated distance Rdet is compared with the set threshold value Rref. On the basis of the comparison, it is determined whether a handoff is needed.

With this configuration, even when the shape of the cell a base station forms and its size differ from one base station to another, the optimum threshold value can be always be set in each station, enabling an accurate determination. Furthermore, even when a base station does not have the function of transmitting its own latitude and longitude data and threshold value data, it is possible to determine whether a handoff is needed on the basis of the distance. In addition, when whether a handoff is needed is determined, there is no need to acquire the latitude and longitude data and threshold value data from the base station each time the determination is made, which enables a simple, quick determination.

(Fifth Embodiment)

The fourth embodiment can be improved as follows. A threshold value table is provided for the mobile communication terminal. In the threshold value table, threshold values Rref are stored in such a manner that they correspond to the base station IDs of the individual base stations. The threshold values Rref are determined in advance, station by station, on the basis of the data representing the shape and size of the cells.

FIG. 7 shows an example of the threshold value table. As shown in FIG. 7, the threshold values set for the three sectors are stored in such a manner that they correspond to each base station ID. For example, in the case of base station BS11, the threshold value of the north-side sector is 1.5 km (N=1.5 km), the threshold value of the southeast-side sector is 1.0 km (SE=1.0 km), and the threshold value of the southwest-side sector is 1.8 km (SW=1.5 km).

The mobile communication terminal not only calculates latitude and longitude data about the terminal from, for example, the GPS signals from a plurality of satellites received by the GPS receiver, but also receives the notice information transmitted from the synchronized base station and extracts the latitude and longitude data about the base station from the received notice information. Then, on the basis of the calculated latitude and longitude data about the terminal and the extracted latitude and longitude data about the base station, the distance Rdet from the terminal to the base station is calculated.

On the other hand, the base station ID is extracted from the notice information transmitted from the base station and the threshold value Rref corresponding to the extracted base station ID is read from the threshold value table. Then, the calculated distance Rdet is compared with the read-out threshold value Rref. On the basis of the result of the comparison, it is determined whether a handoff is needed.

With this configuration, even when the shape of the cell a base station forms and its size differ from one base station to another, whether a handoff is needed can always be determined accurately using the optimum threshold value set for each station, as in the fourth embodiment. Furthermore, even when a base station does not have the function of transmitting the threshold value data, it is possible to determine whether a handoff is needed on the basis of the distance. In addition, when whether a handoff is needed is determined, there is no need to calculate the threshold value Rref each time the determination is made, which makes the determining process simpler accordingly.

While in the fifth embodiment, only the threshold value data has been stored in the threshold value table, latitude and longitude data about the base stations may also be stored. Use of such a table enables the distance from the base station to the terminal to be calculated, even when the base station does not have the function of transmitting its latitude and longitude data.

Furthermore, a common threshold value for all the base stations may be set and stored in each system and whether a handoff is needed may be determined using the common threshold value. With this configuration, one common threshold value is used in each system, which enables the determining process to be carried out very simply. Furthermore, the cell information table and threshold value table are not required, which decreases the memory space needed in the mobile communication terminal. This configuration can be applied to a case where the diameters of the cells the individual base stations in the system form are almost equal.

(Other Embodiments)

The present invention is not limited to the above embodiments. While in the first embodiment, a base station transmits the threshold value data on the basis of the notice information and a mobile communication terminal receives the threshold data and makes a judgment, a base station may also transmit the data regarding the shape of the cell of the base station and its size, and a mobile communication terminal may receive the data representing the shape and size of the cell, set a threshold value on the basis of the received data, and make a determination using the set threshold value. With this configuration, the threshold value can be set on the basis of the latest data transmitted from the base station, which makes it possible to continually set the best threshold value to accommodate changes in the shape and size of the cell the base station forms.

In each of the above embodiments, explanation has been given using an example of an idle handoff in the waiting state. The present invention is not restricted to this and may be applied to a handoff during communication. Specifically, a mobile communication terminal monitors the distance from the base station to the terminal. When the distance has exceeded the threshold value for determining whether a handoff is needed, the mobile communication terminal changes the connection of the communication channel from the present base station to another.

By doing this, whether a handoff is needed is determined, regardless of the reception level of the signal coming from the base station, which makes it possible to execute a handoff stably, without being affected by variations in the characteristics of the radio channel.

Furthermore, a mobile communication terminal may be provided with a circuit that senses the movement speed of the terminal using, for example, an acceleration sensor. According to the movement speed of the terminal sensed by the speed sensing circuit, the terminal sets a period for determining whether a handoff is needed and determines whether a handoff is needed at regular intervals according to the set determining period.

With this configuration, for example, when the movement speed of the mobile communication terminal is fast, whether a handoff is needed is determined in a short period. In contrast, when the movement speed is slow, whether a handoff is needed is determined in a long period. Since whether a handoff is needed is determined frequently when the movement speed is fast, a handoff is performed as early as possible when a handoff is necessary. On the other hand, since handoff necessity judgment is determined less frequently when the movement speed is slow, the power consumption of the mobile communication terminal is reduced.

In addition, the type and configuration of a radio communication system, the radio communication scheme and communication protocol of each system, the type and configuration of a mobile communication terminal, the procedure and contents of the process of determining whether a handoff is needed, and the procedure and contents of handoff control may be embodied in still other ways without departing from the spirit or essential character of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile communication terminal comprising:
a receiving section which receives, from a base station to which the terminal is connected via a radio channel, first position information representing the position of the base station;
a position sensing section which senses second position information representing the position of the terminal;
a distance computing section which calculates a distance from the base station to the terminal on the basis of the first position information received by said receiving section and the second position information sensed by said position sensing section; and
a determining section which determines whether a handoff is needed on the basis of the distance calculated by the distance computing section.

2. The mobile communication terminal according to claim 1, wherein position sensing section includes a satellite signal receiving section which receives a signals from a plurality of distance measuring satellites, and a position computing section which calculates the position of the terminal on the basis of the signals from said plurality of distance measuring satellites received by the satellite signal receiving section.

3. The mobile communication terminal according to claim 1, wherein said determining section compares the distance calculated by said distance computing section with a predetermined threshold value and, on the basis of the result of the comparison, determines whether a handoff is needed.

4. The mobile communication terminal according to claim 1, wherein said determining section includes a threshold value setting section which sets variably a threshold value corresponding to the radio communication area each base station covers, and a comparing section which compares the distance calculated by said distance computing section with the threshold value set by said threshold value setting section and, on the basis of the comparison, determines whether a handoff is needed.

5. The mobile communication terminal according to claim 4, wherein said threshold value setting section extracts information representing the size of the radio communication area the base station covers from the system information transmitted from the base station and, on the basis of the extracted information, sets the threshold value corresponding to the base station.

6. The mobile communication terminal according to claim 4, wherein said threshold value setting section has a first memory which stores the information representing the size of the radio communication area the base station covers in such a manner that the information corresponds to identification information about each base information, and on the basis of the identification information about the base station to which the terminal is connected, reads the information representing the size of the radio communication area corresponding to the base station from the first memory and, on the basis of the read-out information, sets the threshold value corresponding to the base station.

7. The mobile communication terminal according to claim 4, wherein said threshold value setting section has a second memory which stores the threshold value preset according to the radio communication area the base station covers in such a manner that the threshold value corresponds to each piece of identification information about a plurality of base stations, and on the basis of the identification information about the base station to which the terminal is connected, reads the threshold value corresponding to the base station from said memory.

8. The mobile communication terminal according to claim 1, wherein said determining section includes a sensing section which senses the movement speed of the terminal, a setting section which sets a determining period according to the movement speed sensed by the sensing section, and a determination executing section which determines whether a handoff is needed periodically according to the determining period set by the setting section.

9. A mobile communication terminal comprising:
a receiving section which receives, from a base station to which the terminal is connected via a radio channel, first position information representing the position of the base station;
a position sensing section which senses second position information representing the position of the terminal;
a distance computing section which calculates a distance from the base station to the terminal on the basis of the first position information received by said receiving section and the second position information sensed by said position sensing section;
a determining section which, determines whether a handoff is needed on the basis of the distance calculated by the distance computing section; and
a handoff executing section which executes a handoff process when said determining section has determined that a handoff is needed.

10. The mobile communication terminal according to claim 9, wherein said handoff executing section permits a second handoff process after a predetermined waiting time has elapsed since a first handoff process was executed.

11. The mobile communication terminal according to claim 9, wherein when the mobile communication terminal can be selectively connected via a radio channel to a base station in a first mobile communication system and a base station in a second mobile communication system using a radio communication scheme different from that of said first mobile communication system, said handoff executing section, if the determining section has determined that the handoff is needed, executes a first handoff process of switching the connection of the terminal from the base station in said first mobile communication system to which said mobile communication terminal is now connected to the base station in said second mobile communication system.

12. The mobile communication terminal according to claim 9, wherein when the mobile communication terminal can be selectively connected via the radio channel to a plurality of base stations belonging to the same mobile communication system, said handoff executing section, if said determining section has determined that the handoff is needed, executes a second handoff process of switching the connection of the terminal from the base station to which said mobile communication terminal is now connected to another neighboring base station belonging to the same mobile communication system.

13. A handoff control method comprising:
causing a base station to notify a mobile communication terminal of first position information representing the installation position of the base station;
causing the mobile communication terminal to sense second position information representing the position where the mobile communication terminal exists;
calculating the distance between said base station and said mobile communication terminal on the basis of said notified first position information and said sensed second position information; and
determining on the basis of the calculated distance whether a handoff is needed.

14. A handoff control method comprising:
causing a base station to notify a mobile communication terminal of first position information representing the installation position of the base station;
causing the mobile communication terminal to sense second position information representing the position where the mobile communication terminal exists;
calculating the distance between said base station and said mobile communication terminal on the basis of said notified first position information and said sensed second position information;
determining on the basis of the calculated distance whether a handoff is needed; and
executing a handoff process of switching the base station to which the mobile communication terminal is now connected to another one if it has been determined that a handoff is needed.

15. The handoff control method according to claim 14, further comprising permitting a second handoff process to be executed after a predetermined waiting time has elapsed since a first handoff process was executed.
